(19) United States
(12) Patent Application Publication
(10) Pub. No.: US 2011/0181464 A1
(43) Pub. Date: Jul. 28, 2011

(54) Method of Position Determination in a Global Navigation Satellite System (GNSS) Receiver

(75) Inventors: Mikhail Vasilyev, St. Petersburg (RU); Nikolay Mikhaylov, St. Petersburg (RU); Sergey Pospelov, St. Petersburg (RU); Bijan Jalali, Irvin, CA (US)

(73) Assignees: MSTAR SEMICONDUCTOR, INC., Grand Cayman (KY); MSTAR FRANCE SAS, Issy Les Moulineaux (FR); MSTAR SEMICONDUCTOR, INC., Hsinchu Hsien (TW); MSTAR SOFTWARE R&D (SHENZHEN) LTD., NanShan District Shenzhen (CN)

(21) Appl. No.: 12/785,737

(22) Filed: May 24, 2010

(30) Foreign Application Priority Data
Jan. 25, 2010 (RU) 2010102324

(51) Int. Cl. G01S 19/44

(52) U.S. Cl. 342/357.27

(57) ABSTRACT

A method of determining coordinates of a mobile Global Navigation Satellite System (GNSS) receiver includes processing signals from space vehicles including performing measurements of pseudoranges and Doppler shift, extracting ephemeris data, and determining GNSS receiver coordinates from said measurements.

### FIELD OF THE INVENTION

The present invention relates to navigation receivers and, in particular, to the methods of coordinates determination in Global Navigation Satellite System (GNSS) receivers. There exist or are being deployed several Global Navigation Satellite Systems. These are Global Positioning System GPS (USA), Global Navigation Satellite System Glonass (Russia), Galileo (European Space Agency), Beidou or Compass (China).

### BACKGROUND OF THE INVENTION

Navigation receivers receive signals of GNSS space vehicles (SVs), measure parameters of these signals—pseudorange and Doppler shift of carrier frequency. Pseudorange measurement is performed by phase determination of the radio signal subcarrier comprising a pseudo-random sequence (or PRN-code), which is overlaid onto the carrier with the help of phase modulation. In GPS, for example, the subcarriers are Gold codes with a period of 1 millisecond (ms) and code chip rate of 1.023 MHz. In Glonass, the subcarrier is a maximum length sequence (M-sequence) with the same period of 1 millisecond (ms), but with the code chip rate of 511 kHz.

Furthermore, in GNSS, SV transmit, in the same signal, data about this SV orbit, on-board reference oscillator frequency and time scale (ephemeris data). Data is transmitted in signals with the help of phase modulation with data bit rate, equal, for example, in GPS and Glonass to 50 bits per second (bps). Data is grouped into some regularly repeated formats.

In GPS, data formats include “words” (0.6 seconds long), “sub-frames” (10 words, 6 seconds long), “frames” (30 seconds long), “super-frames” (12.5 minutes long). The first word of each sub-frame contains HOW (Handover Word), including TOW (Time of Week), which enables determining time within the receiver with an accuracy required for referencing of measured pseudoranges and Doppler frequencies. The first, second and third sub-frames of each data frame contain ephemeris data.

In Glonass, data formats include “lines” (2 seconds long), “frames” (30 seconds long) and “super-frame” (2.5 minutes long). Ephemeris data is placed in the four leading lines of each Glonass data frame. Each data line carries several parameters of ephemeris data. Timing information is in the tk parameter placed in the first line of each data frame.

Data reception in a navigation receiver starts from data bit edges synchronization. Indeed, PRN-code synchronization defines signal arrival time within this code period (1 millisecond), but gives no knowledge of bit edges location within the bit duration of 20 ms, which corresponds to the data rate of 50 bps. After the data bit synchronization is achieved, the receiver starts demodulating data bits, verifying received bits with the help of error correction codes involving check bits embedded in the data. Finally, the stream of bits is decoded to extract formats of data (in GPS: words, sub-frames, frames, super-frame).

Space vehicles of GNSS are orbiting the Earth at the height of about 20000 km. Correspondingly, typical propagation time of signals from SV to the receiver is about from 60 to 80 ms. So, a full (unambiguous) pseudorange must be expressed (measured) in the range up to 80 ms. After PRN code synchronization resulting from the signal acquisition process, ambiguous 1-millisecond (or incomplete) pseudorange measurements become available. This means that the measured pseudorange is correct in its 1-millisecond part, but does not contain an unknown integer number of 1-millisecond intervals that are necessary to be added to the incomplete (ambiguous) pseudorange for its full representation. Thus, after the initial stage of synchronizing to GNSS (GPS, Glonass) signals, 1-millisecond pseudoranges are available.

Acquiring synchronization with satellite data bits transmitted within GNSS (GPS, Glonass) signals allows to extend the interval of unambiguous representation of pseudorange up to 20 milliseconds. In this case, it is said that 20-millisecond (still, incomplete) pseudoranges are available in the receiver.

Full (or complete) pseudoranges are measured in the GNSS receiver after reception of timing data (TOW in GPS, or tk in Glonass) from one SV of the GNSS, at least.

Some time must be spent in the receiver for data bit synchronization and reception of timing data enabling full pseudoranges measurement. The amount of this time depends on the receiver design peculiarities and condition of signals reception. Approximately, the time spent to acquire bit synchronization may reach from fractions of a second up to several seconds. Timing data transmitted by GNSS SVs (TOW in GPS, or tₖ in Glonass) have repetition period equal to 6 seconds in GPS and 30 seconds in Glonass. Accounting for the random beginning of the reception and applying in the receiver, typically, some additional data checks to improve data reliability in the receiver, tentatively, from 10 to 40 seconds may be spent to receive timing data even under unobstructed GNSS signals reception conditions (strong signals).

Under obstructed GNSS signals reception conditions, for example, indoors, or in urban canyons, signal-to-noise ratio reduction may lead to a further multiple growth of time spent to get full pseudoranges, or, even, to inability to get them at all. At the same time, often, ambiguous pseudoranges may be measured by the receiver even with weak signals and ephemeris data may be available from alternate sources. For example, in GNSS receivers aimed to track vehicles, ephemeris data may be preloaded into the receiver for the whole time of forthcoming expedition. Another example is the technique of long term (for several days) prediction of ephemeris within the GNSS receiver, which gets now wider use.

In this way, positioning in GNSS receivers with incomplete (ambiguous) pseudoranges is a problem of current importance.

A method to solve this problem is known from U.S. Pat. No. 7,535,414, which assumes that while computing the coordinates of the navigation receiver, the uncertainties of incomplete pseudorange measurements are resolved by including them into the vector of estimated parameters. At that, Doppler measurements are used to get initial approximation of the receiver coordinates and the uncertainty value of pseudorange measurement of a selected reference SV signal. Integer number uncertainties of pseudoranges can be fixed only when a definite accuracy of computing them is achieved. Disadvantages of the method can be listed, which are comparatively complex computations, a need to form additional combinations of measurements—pseudorange differences, a big dimension of matrices involved into calculations and great probability that, to resolve the uncertainties of incomplete pseudoranges, more than one set of common time measurements will be required that may lead to increase of time to the first coordinates fix of the GNSS receiver. These disadvantages show a significant complication, as compared with the classical method of coordinates calculation in GNSS receivers with complete pseudoranges.

Another method, which is described in U.S. Pat. No. 6,417,801, suggests resolving of uncertainties of incomplete pseudoranges by adding the correction to the time of measurements into the vector of estimated parameters, testing all possible integer combinations of uncertainties and choosing the appropriate one by the criterion of minimal residuals. However, this method, in spite of its simplicity, also has significant disadvantages. This is, in one option, a necessity to get information about sufficiently accurate initial coordinates of the GNSS receiver, for example, from a mobile communication base station. This implies sophistication of the GNSS receiver to receive the data. In another option, a long search across the set of initial coordinates is required to find the ones, which allow the method to calculate the GNSS receiver coordinates. The search includes calculating model pseudoranges across some net of possible initial approximations to the true GNSS receiver coordinates, which is the most resource-intensive process in coordinates determination of a GNSS receiver.

### SUMMARY OF THE INVENTION

The present invention is aimed to create a new method of extremely fast accurate coordinates determination in a GNSS receiver, a method, which does not have the mentioned above disadvantages of the known methods, that is, it does not require additional external information, long search across uncertainties of pseudorange measurements, or significant sophistication of computational scheme, as compared with coordinates determination with complete pseudoranges.

The technical result achieved by the present invention is the possibility to determine GNSS receiver coordinates on those time intervals when decoding of time correction data from SV signals is not possible and, as a consequence, accurate time tagging of the measurements to GNSS time scale is absent and the measurements are incomplete, that is, are accomplished as modulo 1 millisecond, or modulo 20 milliseconds.

The task is solved in the following way.

The suggested method of determining coordinates of a mobile receiver of Global Navigation Satellite System (GNSS), assuming that the receiver picks up and processes signals from space vehicles, basing on said processing, performs measurements of pseudoranges and Doppler shift, extracts ephemeris data, and determines GNSS receiver coordinates from said measurements according to the following steps:
at the first step, ambiguity modulo N is defined from the errors δ of GNSS receiver initial coordinates in the following way: N equals to 1 millisecond for δ values below 150 kilometers, and N equals to 20 milliseconds for δ values from 150 up to 3000 kilometers,
at the second step, measured pseudoranges with ambiguity modulo greater or equal to N are counted, and, in case when said pseudoranges count is not enough for the GNSS receiver coordinates determination, the initial coordinates are adjusted from Doppler measurements, and, if the adjustment was not successful, new pseudorange and Doppler measurements, and data extraction are accomplished, and, if the adjustment was successful, the steps 1 and 2 are executed in a cyclic manner until the coordinates determination become possible from pseudorange measurements with uncertainty modulo equal or greater than N, and after this, basing on the initial GNSS receiver coordinates, the initial approximation of the time of measurements and the ephemeris data, the iterative process of the GNSS receiver coordinates calculation with pseudorange measurements is performed according to the following steps:
at the third step, modeled pseudorange values, pseudorange residuals defined as differences between their measured and modeled values by the modulo N milliseconds, and the matrix of derivatives by the adjusted parameters are calculated,
at the fourth step, minimization of residuals is accomplished by adding or subtracting N milliseconds to their calculated values, and, after that, the iterative process of GNSS receiver coordinates calculation with pseudorange measurements is performed including the following steps:
at the fifth step, corrections to GNSS receiver coordinates with all combinations of residuals possible within the limit of the uncertainty modulo N, with the matrix of derivatives by the adjusted parameters, and the minimal correction set among all the combinations are calculated,
at the sixth step, corrections to GNSS receiver coordinates by pseudorange residuals and the matrix of derivatives by the adjusted parameters are calculated,
at the seventh step, the corrections are added to the GNSS receiver coordinates,
while at the first iteration, after step 4, steps 5 and 7 are performed, and at the following iterations, after step 4, steps 6 and 7 are performed, and, when the corrections to GNSS receiver coordinates become small enough to provide required accuracy of GNSS receiver coordinates calculation, iterations are interrupted, otherwise the process comes back to step 3, and further iterations are accomplished while the mobile GNSS receiver coordinates from the last iteration are taken as the starting point.

### BRIEF DESCRIPTION OF THE DRAWINGS

The method of present invention is illustrated by the following figures.

FIG. 1 is a block diagram of the major components of a GNSS receiver utilizing the method of present invention.

FIG. 2 is a block diagram of the correlator engine of the GNSS receiver utilizing the method of present invention.

FIG. 3 shows a generalized timing diagram characterizing components of the Time-to-First Fix (TTFF) in the GNSS receiver.

FIG. 4 shows a data flow diagram in an example embodiment of the method of present invention.

FIG. 5 is a flow chart describing the sequence and logic of operations in the method of present invention.

### DETAILED DESCRIPTION OF THE PREFERRED EMBODIMENT

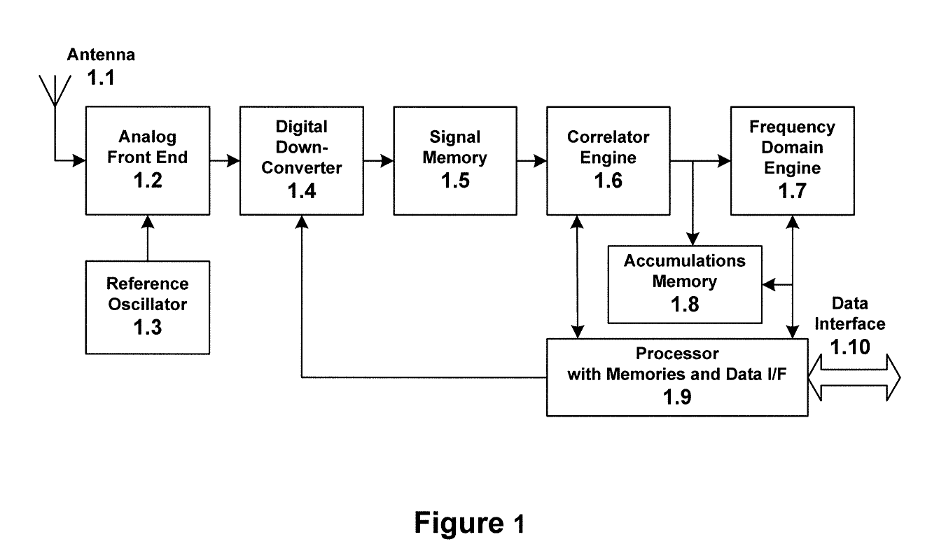

The preferred embodiment of the method of present invention is further described by the example of the GNSS receiver functioning illustrated by the block diagram shown in FIG. 1. The Analog Front-End 1.2 amplifies, transfers to an intermediate frequency, selects and digitizes, that is, transforms into a sequence of digital samples, signals of GNSS SVs collected by the Antenna 1.1. At that, the Analog Front-End 1.2 utilizes signal from the Reference Oscillator 1.3, which serve also to form the time scale of the GNSS receiver. The Digital Down-Converter 1.4 controlled by the Processor 1.9 transforms GNSS signal samples to baseband frequency and, generally, performs its additional processing, for example, jamming rejection, changing sampling rate (for example, samples decimation), additional digital filtering. The converted samples at baseband frequency are placed for storing into the Signal Memory 1.5. Samples write rate to the Signal Memory 1.5 must match the bandwidth of selected signals and meet commonly accepted Nyquist requirement. Thus for GPS C/A signals having PRN-code chip rate close to 1 MHz, the rate of complex digital samples must not be less than 2 MHz. Samples from the Signal Memory 1.5 are read to the Correlator Engine 1.6 at a rate higher than that of write to the Signal Memory 1.5. In this way, acceleration of getting multiple correlation accumulations for different signal parameters' hypotheses is achieved what is required for effective processing of weak GNSS signals. Correlation accumulations acquired in the Correlator Engine 1.6 are stored in the Accumulations Memory 1.8. Then, the Frequency Domain Engine 1.7 performs transformation of the series of correlation accumulations into spectra of signal power. In the preferred embodiment of present invention, the Frequency Domain Engine 1.7 utilizes Fast Fourier Transform (FFT). As an example of transform in the Frequency Domain Engine 1.7, a 64-point FFT may be used. Intermediate storing of power spectra is accomplished in the Accumulations Memory 1.8. Controls over the GNSS receiver operation and performing numerous algorithmic and calculation steps is performed in block 1.9, which comprises a processor with associated program and data memories and data interface controllers enabling external data transfers through the Data Interface bus 1.10.

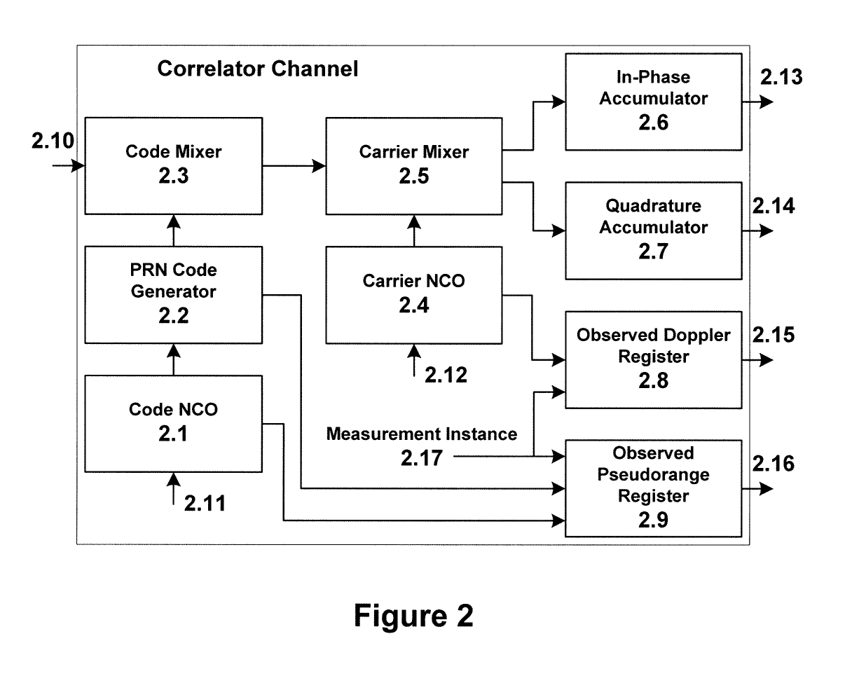

The Correlator Engine 1.6, in one of possible embodiments of present invention, comprises multiple parallel correlator channels. An example of correlator channel implementation is presented in FIG. 2. Signal samples 2.10 read from the Signal Memory 1.5 are fed to the input of the Code Mixer 2.3. The Code NCO (Numerically Controlled Oscillator) 2.1 and the Carrier NCO 2.4, according to control signals 2.11 and 2.12 comprising frequency and phase of the signal replica, from the Processor 1.9, produce locally generated replica signal components, which are applied, the former—via the PRN Code Generator 2.2 to the Code Mixer 2.3, and, the latter directly—to the Carrier Mixer 2.5, correspondingly. The output of the Code Mixer 2.3 is connected to the second input of the Carrier Mixer 2.5. The results of complex multiplication in the Carrier Mixer 2.5 are fed to the In-Phase Accumulator 2.6 and the Quadrature Accumulator 2.7, which form the correlation statistics (accumulations) 2.13 and 2.14. Current values from the Code NCO 2.1, the PRN Code Generator 2.2 and the Carrier Mixer 2.4 are latched into the Observed Pseudorange Register 2.9 and the Observed Carrier Register 2.8, the corresponding outputs of which are pseudorange 2.16 and Doppler measurements 2.15. The pseudorange 2.16 is an incomplete modulo 1 millisecond pseudorange. Synchronization with data bit edges and data reception and decoding (decoding of data formats) are performed based on the correlation statistics (accumulations) 2.13 and 2.14. Reception and storing of the ephemeris data is accomplished by the Processor 1.9.

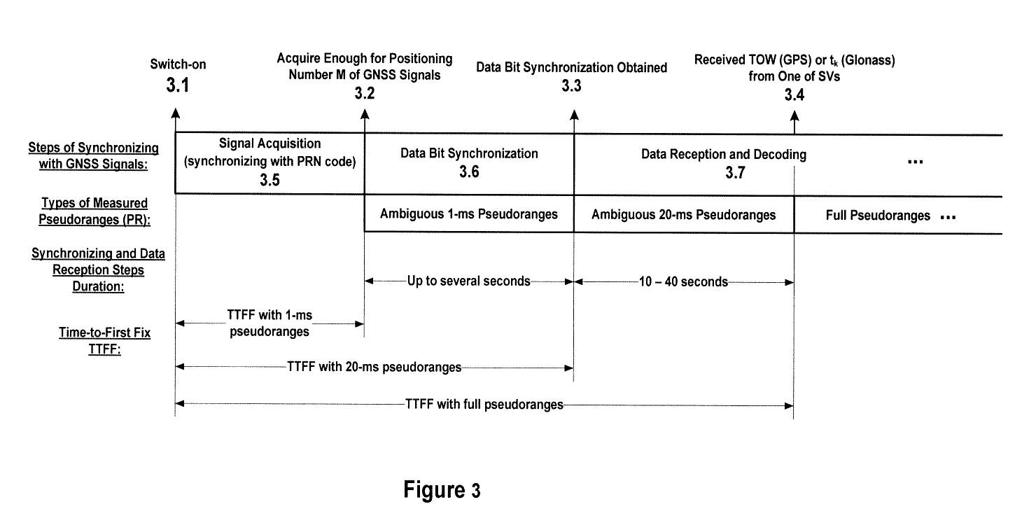

Stages of synchronization with the GNSS signals in the receiver are illustrated by the timing diagram of FIG. 3. On the time scale in FIG. 3, beginning from the receiver switch-on instant 3.1, the following stages are presented: 3.5—the stage of signal acquisition (PRN code synchronization); 3.6—the stage of data bit synchronization; 3.7—the stage of data reception and decoding.

During the data bit synchronization stage of SV signals, incomplete, that is, 1-millisecond pseudorange measurements are available. During the data reception and decoding stage of SV signals, that is, after the event 3.3 and before the event 3.4,—incomplete 20-millisecond pseudorange measurements for these SVs are available. After the event 3.4, complete pseudorange measurements become available. When a sufficient number of incomplete pseudorange measurements of GNSS SVs signals is available, and when the ephemeris data is present for these SVs, the method of present invention allows to get position solution before complete pseudoranges become available.

Time interval from the receiver switch-on till the first positioning fix (TTFF—Time-to-First Fix) with complete pseudoranges, that is, after the event 3.4 of reception of TOW (GPS) or tk (Glonass) from one of the GNSS SVs, as it is seen from the timing diagram of FIG. 3, includes the time of data bit synchronization (3.6), which may reach several seconds, and the time of data reception and decoding 3.7 (information about GNSS time), which may reach, for example, from 10 to 40 seconds. On the other hand, the TTFF with 1-ms pseudoranges is defined by the time interval to the event 3.2. Accounting that in modern receivers the time of signal acquisition (PRN code synchronization) may be rather short, for example, depending on the signals strength and quality of a priori information about receiver position and time, from fractions of a second and up to first units of seconds, it becomes clear that using, for the coordinates determination, of incomplete pseudoranges may decrease the TTFF by several times, as compared with the use of complete pseudoranges.

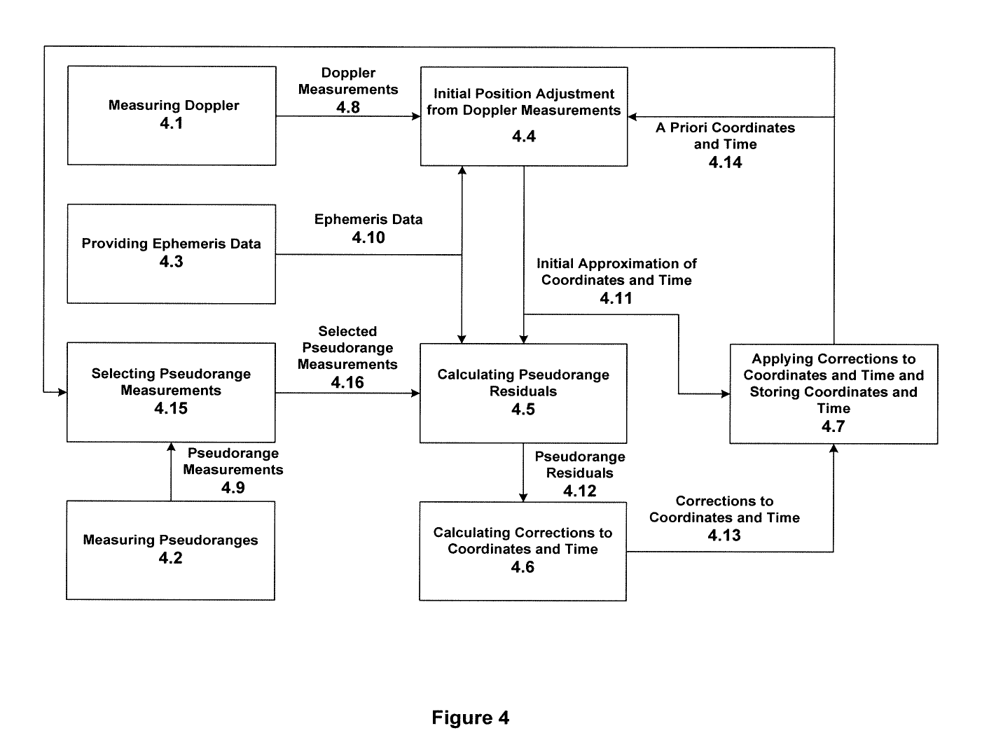

The essence of the present invention may be described as follows with references to the data flow diagram of FIG. 4. Measuring Doppler 4.1 is accomplished in the Correlator Engine 1.6 as described above. Measuring Pseudoranges 4.2 of pseudorange measurements 4.9 is accomplished in the processor 1.9 based on 1-millisecond pseudoranges received from the correlator engine 1.6, information about bit edge synchronization obtained at the step 3.6, and TOW (GPS), or tk (Glonass) obtained at the step 3.7 of data reception and decoding. As the result, the incomplete 1-millisecond, the 20-millisecond, or the complete pseudoranges are obtained. It is significant that both Doppler and pseudorange measurements are always accompanied by the time instant in the GNSS receiver internal time scale. Depending on the errors of priori coordinates and time 4.14, appropriate pseudorange measurements 4.15 are selected from all pseudorange measurements 4.9.

Ephemeris data 4.10, from the block 4.3 providing ephemeris data, comes to block 4.5 calculating pseudorange residuals. Ephemeris data 4.10 is received on step 3.7 of data reception and decoding, or becomes available from alternate sources. For example, in GNSS receivers aimed to track vehicles, ephemeris data may be preloaded into the receiver for the whole time of forthcoming expedition. Another example is the technique of long term (for several days) prediction of ephemeris within the GNSS receiver, which gets now wider use.

A more exact initial approximation of coordinates and time 4.11 is calculated within the Initial Adjustment 4.4 from Doppler measurements 4.8, ephemeris data 4.10 and a priori coordinates and time 4.14, and this more exact initial approximation 4.11 is further stored in block 4.7.

Calculating Pseudorange Residuals 4.5 is accomplished for selected pseudorange measurements 4.16 with the adjusted initial approximation of coordinates and time 4.11 and involving the ephemeris data 4.10.

From the residuals 4.12 from block 4.5, Calculating 4.6 of Corrections to Coordinates and Time 4.13 is performed. In block 4.7, Applying of the Corrections to and storing the Coordinates and Time of the GNSS receiver is accomplished.

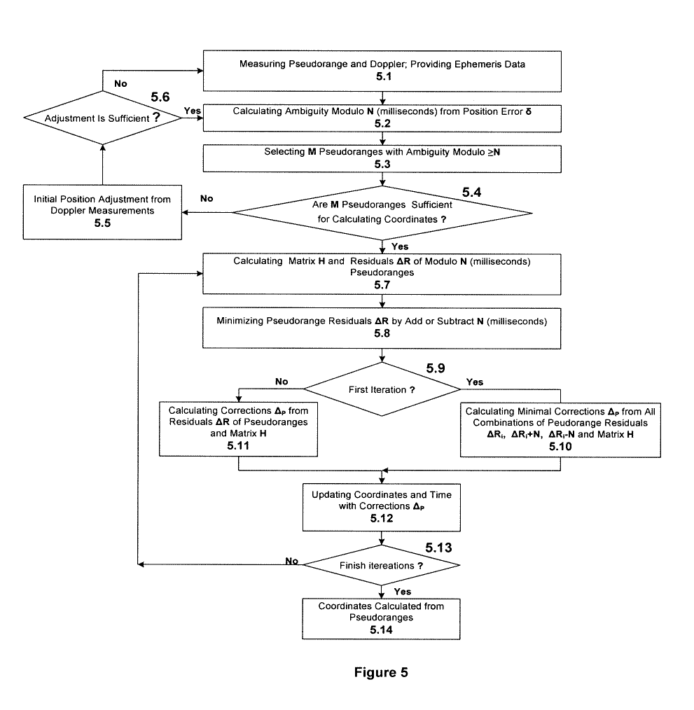

Steps of applying the method of the present invention are illustrated by the flow diagram of FIG. 5.

As described above, the GNSS receiver receives and processes the signals from SVs, thus measuring incomplete 1-millisecond, 20-millisecond, or complete pseudoranges, Doppler shifts, and provides ephemeris data for the SVs of the GNSS. As a rule, there exists information about a priori coordinates and time 4.14 in the receiver. Typically, this information is accompanied by an estimate of the position error δ.

From the received and processed signals of L SVs, Measuring Pseudoranges and Doppler, and Providing Ephemeris Data are accomplished (block 5.1).

In block 5.2, Calculating Ambiguity Modulo N (milliseconds) from Position error δ is performed in the following way: N=1 for δ<150 km, and N=20 for 150 km≦δ<3000 km.

In block 5.3, Selecting M Pseudoranges with Ambiguity Modulo ≧N is performed. The logic block 5.4 tests, if the quantity M of pseudoranges is sufficient to calculate the receiver coordinates.

In block 5.5, Initial Position Adjustment from Doppler Measurements is performed using the following corrections vector Δ_{D}:

$${Δ}_{D} = [ Δ x , Δ y , Δ z , Δ T , Δ ( \frac{d x}{d t} ) , Δ ( \frac{d y}{d t} ) , Δ ( \frac{d z}{d t} ) , Δ F ] , \qquad ( 1 )$$

Where Δx, Δy, Δz—corrections to initial coordinates;

$$Δ ( \frac{d x}{d t} ) , Δ ( \frac{d y}{d t} ) , Δ ( \frac{d z}{d t} ) - corrections to the initial speed ;$$

ΔF—correction to the frequency of reference oscillator 1.3;

t—time;

ΔT—correction to the time of measurements.

Equations to calculate Δ_{D} in block 5.5 may be represented as follows:

G·Δ_{C}=Δ\dot{R}, (2)

Where Δ\dot{R}—vector of differences of measured Doppler values and their modeled values, which has the dimension L;

G—matrix of derivatives by the adjusted parameters, L rows of which are:

$$[ \frac{d {R}_{i}}{d x} , \frac{d {R}_{i}}{d y} , \frac{d {R}_{i}}{d z} , \frac{d {R}_{i}}{d t} , \frac{d {\dot{R}}_{i}}{d x} , \frac{d {\dot{R}}_{i}}{d y} , \frac{d {\dot{R}}_{i}}{d z} , 1 ] ;$$

R—modeled distance to the i-th SV;

i=1, . . . , L;

x,y,z—initial coordinates.

In block 5.5, for calculating of the vector Δ\dot{R} of differences between the pseudorange measured and modeled values, and of the matrix G of derivatives, ephemeris data from block 5.1 is used. Corrections Δ_{D} are added to initial coordinates within block 5.5 in several iterations, which are stopped when corrections to initial coordinates Δ_{D} become small enough to enable required accuracy of initial coordinates adjustment, for example, below one kilometer. The error δ of the initial coordinates adjustment by Doppler measurements is, normally, significantly less than 150 km.

Solution of the equation (2) with the reduction of coordinates' error δ, and, correspondingly, adjustment of initial coordinates may happen or not, that is tested by the logical block 5.6. Blocks 5.1, 5.2, 5.3, 5.5 and 5.6 are executed in a cyclic manner until the test in block 5.4 allows passing to coordinates calculation with M pseudoranges.

At the next step in block 5.7, based on initial coordinates, initial approximation of time of measurements and ephemeris data from block 5.1, modeled values of pseudoranges, the matrix H of derivatives, which will be defined below, and pseudorange residuals ΔRⱼ(j=1, . . . , M), which are equal to differences of measured and modeled values of pseudoranges, are calculated. As the error δ of coordinates is less than N/2*c km (c—speed of light, N/2*c equals to 150 km, if N=1, and N/2*c equals to 3000 km, if N=20), deviations of ΔRⱼ from their average values must be less than N/2 milliseconds. If any of the residuals ΔRⱼ is greater than N/2 milliseconds, then, in block 5.8, N milliseconds are subtracted. If any of the residuals ΔRⱼ is less than −N/2 milliseconds, then, in block 5.8, N milliseconds are added. Minimized in this way residuals ΔR are the output of block 5.8.

As any of the residuals may have the uncertainty equal to ±N milliseconds, then the whole set of possible ΔRⱼ, ΔRⱼ+N, ΔRⱼ−N, may be used throughout the further processing.

Calculating the receiver coordinates from the pseudorange measurements is accomplished using the corrections vector

Δ_{P}=(Δx,Δy,Δz,Δt,ΔT).

The system of equations to find the corrections Δ_{P} may be represented, as

H·Δ_{P}=ΔR, (3)

Where H is the matrix of derivatives by the adjusted parameters calculated in block 5.7, M rows of which are as follows:

$$[ \frac{d {R}_{j}}{d x} , \frac{d {R}_{j}}{d y} , \frac{d {R}_{j}}{d z} , 1 , \frac{d {R}_{j}}{d t} ] ;$$

j=1, . . . , M;
Δt—correction to the timescale of the GNSS receiver.

To solve the system of equations (3), an iteration process is applied, which is controlled by the logic block 5.13. During the first iteration, commanded by the logic block 5.9, all possible correction vectors Δ_{P} are calculated in block 5.10 for all combinations of pseudorange residuals ΔRⱼ, ΔRⱼ+N, ΔRⱼ−N and the derivative matrix H. The minimal correction Δ_{P} among those corresponding to the pseudorange residuals ΔRⱼ, ΔRⱼ+N, ΔRⱼ−N is the output of block 5.10 and serves to be applied to the coordinates and time in block 5.12. On all other iterations except the first one, the correction vector Δ_{P} is calculated in block 5.11 from the residuals vector ΔR and the derivative matrix H. Blocks 5.7-5.12 are executed in a cyclic manner until the test in the logic block 5.13 shows that corrections Δ_{P} are small enough to provide required accuracy of coordinates calculation. For example, corrections below 0.1 meter may be required.

Coordinates of the GNSS receiver are the output of block 5.14.

As described above, the present invention enables solving the task of GNSS receiver coordinates determination from incomplete (ambiguous) measured pseudoranges by a simpler method than that disclosed in U.S. Pat. No. 7,535,414. The simplification is achieved because of the following factors. Inclusion of the parameter ΔT into the vector Δ_{P} allows to avoid introducing a reference SV and determining additional combinations of measurements-pseudorange differences, and to avoid determining the uncertainty value of incomplete (ambiguous) pseudorange of the reference SV while adjusting the receiver coordinates from Doppler measurements. The criterion of minimizing corrections Δ_{P} to initial coordinates based on a search through the reduced set of residuals ΔRⱼ, ΔRⱼ+N, ΔRⱼ−N allows to avoid including uncertainties of incomplete pseudoranges into the vector of corrections Δ_{P} that enables to reduce the dimension of matrices involved into calculations and raise the probability of determining the GNSS receiver coordinates from single-instant measurements of incomplete pseudoranges.

Making use of initial position adjustment from Doppler measurements (block 5.5) and of the criterion of minimizing corrections to the initial coordinates instead of the criterion of minimizing pseudorange residuals allows reducing significantly the amount of calculations as compared with the method disclosed in U.S. Pat. No. 6,417,801. The major calculation effort reduction is due to eliminating of modeled pseudorange calculation across the grid of initial approximations to the coordinates, which is the most effort-consuming process of the conventional method of GNSS receiver coordinates determination.

What is claimed is:

1. A method of determining coordinates of a mobile receiver of Global Navigation Satellite System (GNSS), assuming that the receiver receives and processes signals from space vehicles, based on said processing, performs measurements of pseudoranges and Doppler shift, extracts ephemeris data, and determines GNSS receiver coordinates from said measurements according to the following steps:
at step 1, defining an ambiguity modulo N from an error δ of GNSS receiver initial coordinates;
at step 2, counting a plurality of measured pseudoranges with ambiguity modulo greater or equal to N, and, in case when said pseudoranges count is not enough for the GNSS receiver coordinates determination, adjusting the initial coordinates from Doppler measurements, and after the adjustment, based on the initial GNSS receiver coordinates, the initial approximation of the time of measurements and the ephemeris data, performing the iterative process of the GNSS receiver coordinates calculation with pseudorange measurements according to the following steps:
at step 3, calculating modeled pseudorange values, pseudorange residuals defined as differences between their measured and modeled values by the modulo N milliseconds, and the matrix of derivatives by the adjusted parameters;
at step 4, minimizing the pseudorange residuals by adding or subtracting N milliseconds to their calculated values, and, after that minimization process, performing the iterative process of GNSS receiver coordinates calculation with pseudorange measurements according to the following steps:
at step 5, calculating corrections to GNSS receiver coordinates with all combinations of residuals possible within the limit of the uncertainty modulo N, with the matrix of derivatives by the adjusted parameters, and the minimal correction set among all the combinations;
at step 6, calculating corrections to GNSS receiver coordinates by pseudorange residuals and the matrix of derivatives by the adjusted parameters; and
at step 7, adding the corrections to the GNSS receiver coordinates;
while at the first iteration, after step 4, steps 5 and 7 are performed, and at the following iterations, after step 4, steps 6 and 7 are performed, and, when the corrections to GNSS receiver coordinates become small enough to provide required accuracy of GNSS receiver coordinates calculation, iterations are interrupted, otherwise the process returns to step 3, and further iterations are accomplished while the mobile GNSS receiver coordinates from the last iteration are taken as the starting point.

2. The method of claim 1, wherein, at step 1, the ambiguity modulo N is defined from the error δ of GNSS receiver initial coordinates in the following way: N equals to 1 millisecond for δ values below 150 kilometers, and N equals to 20 milliseconds for δ values from 150 up to 3000 kilometers.

3. The method of claim 1, wherein, at step 2, if the adjustment of the initial coordinates from Doppler measurements was not successful, new pseudorange and Doppler measurements, and data extraction are accomplished, and, if the adjustment was successful, the steps 1 and 2 are executed in a cyclic manner until the coordinates determination become possible from pseudorange measurements with uncertainty modulo equal to or greater than N.
